(19) United States
(12) Patent Application Publication
(10) Pub. No.: US 2007/0039486 A1
(43) Pub. Date: Feb. 22, 2007

(54) Homsey's better bread box and bag

(76) Inventor: Michael Homsey III, Baltimore, MD (US)

Correspondence Address: Michael Homsey III, 10414 Bird River Road, Baltimore, MD, 21220-1508, US

(21) Appl. No.: 11/207,822

(22) Filed: Aug. 22, 2005

(51) Int. Cl. A01J 15/14

(52) U.S. Cl. 99/467

(57) ABSTRACT

The Homsey's Better Bread Box and Bag innovation simultaneously mitigate both molding and drying of bread during shipping and storage. The storage containers are intended for use in areas of the world where molding or drying out of bread is problematic. The storage containers are designed for use with refrigeration units (typically a residential refrigerator) and will maintain an interior relative humidity higher then the ambient relative humidity without the use of electricity. The innovation is intended for storing a broad selection of items such as but not limited to breads, reeds (for musical instruments), cakes, pies, cigars, potatoes and many other vegetables.

### CROSS-REFERENCE TO RELATED APPLICATIONS

Not Applicable.

### FEDERALLY SPONSORED RESEARCH

Not Applicable.

### SEQUENCE LISTING OR PROGRAM

Not Applicable.

### BACKGROUND OF THE INVENTION

Residential storage of bread has been a problem in low humidity areas throughout the world due to bread drying out, and areas of high humidity where temperatures fall around the optimal range for mold growth: about 71.6° F. (22° C.) to 86.6° F. (30° C.). Storing bread in low humidity environment causes bread to dry out resulting in stale bread. Simply placing bread in a residential refrigerator can cause low humidity storage of bread. Residential refrigerators lower the humidity surrounding the bread therefore expediting the process of bread becoming stale as it dries out. This often happens when homeowners try to solve the problem of bread molding by placing bread in a residential refrigerator.

Las Vegas, with a 21% average relative humidity in the afternoon and Denver with a 40% average relative humidity in the afternoon, are examples of low humidity locations were countertop storage of bread can result in stale bread within a short period of time. Key West, Fla. (77.8° F. and 74% relative humidity) and Corpus Christi, Tex. (71.6° F. and 77% relative humidity) are examples of areas where the average yearly temperature and humidity falls within the range for mold to thrive. There are numerous other locations around the world that have molding and staling seasons such as Baltimore, Md.

It has been reported that a good rule of thumb is that the rate of mold growth halves for every 18° F. (10° C.) decrease in temperature. Although lowering the temperature surrounding bread can mitigate the problem of mold growth, placing bread in a typical residential refrigerator causes the bread to dry out. The Homsey's Better Bread Box allows bread to be stored in a residential refrigerator by mitigating the drying out process. In addition, the Homsey's Better Bread Box mitigates the problem of soggy bread when bread is stored at or near 100% relative humidity, which can happen when bread is placed in a closed chamber with a water source.

In addition to bread, extending the shelf like of other items such as cigars with a reported optimum storage environment of 70% to 72% relative humidity and 68° F. to 70° F. is another application of Homsey's Better Bread Box and Bag architecture. Other applications include but not limited to reeds (for musical instruments), cakes, pies, potatoes and many other vegetables.

### BACKGROUND OF INVENTION—OBJECTIVE AND ADVANTAGE

The objective of Homsey's Better Bread Box and Bag is to mitigate molding and drying out of bread, hence extending the shelf-life of bread in humid and dry climates such as the Gulf Coast and areas in Colorado, respectively.

The advantage of the Homsey's Better Bread Box and Bag is three fold: extended shelf-life of bread (and many other items), low cost, and the Homsey's Better Bread Box and Bag doesn't required electricity to operate in a residential refrigerator. The economic benefit of the Homsey's Better Bread Box and Bag over industrial storage equipment that regulates humidity is cost. In addition, providing an affordable residential way to mitigate the lost of countless loafs of bread due to molding and staling is another huge economic benefit. It has been estimated that membrane cost to implement a Homsey's Better Bread Box and Bag could cost less than 0.2 cents [$0.002 U.S. dollars in 2005 dollars for about 2 square inches of membrane] per small bags and small boxes.

### SUMMARY OF INVENTION

Homsey's Better Bread Box and Bag (BBB) extends the shelf-life of bread by simultaneously mitigating bread's two primary enemies: staling (drying) and molding. The BBB innovation is a low cost approach to allow bread to be refrigerated without drying out through humidity regulation. Humidity regulation is accomplished using a membrane that changes permeance as a function of humidity and a humidity source in a quasi-closed chamber. Increases in material cost for some applications could be less than 0.2 cent [$0.002 dollar in 2005 dollars] per small bags and small boxes. [Permeance is the moisture transmission rate of a material divided by the material thickness.]

### BRIEF DESCRIPTION OF FIGURES, GRAPH, AND PICTURES

FIG. 1—Homsey's Better Bread Box and Bag diagram

FIG. 2—Typical water vapor response graph

FIG. 3—Typical Better Bread Box cross section

FIG. 4—Typical Better Bread Bag cross section

FIG. 5—First working proof of concept Bread Box

FIG. 6—First working proof of concept Bread Bag

FIG. 7—Proof of concept Bread Box under test

FIG. 8A—Typical membrane cross section (No membrane)

FIG. 8B—Typical membrane cross section (Single wall membrane)

FIG. 8C—Typical membrane cross section (Double wall membrane with air spacer)

FIG. 8D—Typical membrane cross section (Double wall membrane with physical spacer)

FIG. 9—Proof of concept Bread Box with 50 percent larger orifice B than FIG. 5

FIG. 10—Proof of concept Cake and Pie Box under test

### DETAILED DESCRIPTION OF THE INVENTION

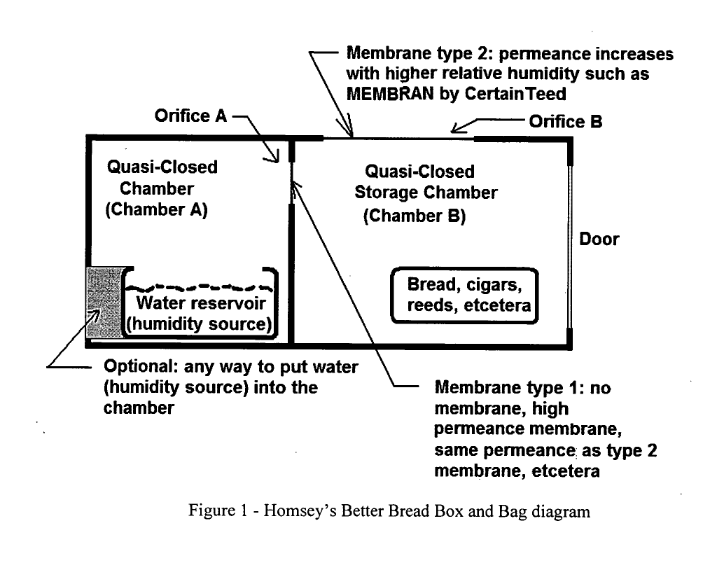

This written specification refers to the FIG. 1—Homsey's Better Bread Box and Bag diagram. The Homsey's Better Bread Box and Bag (BBB) is a two-chamber device used to store food or other items at an elevated relative humidity over the ambient relative humidity outside the storage box or bag. The chambers are referred to as “quasi-closed” chambers because the BBB uses the principle of evaporation in a closed container to raise the relative humidity but employs a membrane that allows water vapor to exit the chamber through a process such as diffusion. The steady-state relative humidity of any open chamber will be the ambient relative humidity; and the steady state relative humidity of a closed chamber will be 100% relative humidity when the chamber achieves saturated vapor pressure. The BBB allows the food storage chamber B to have a relative humidity anywhere between ambient relative humidity [such as an open chamber] and 100% relative humidity [such as a closed chamber] through the selection of the membrane(s) material and orifice(s) sizes.

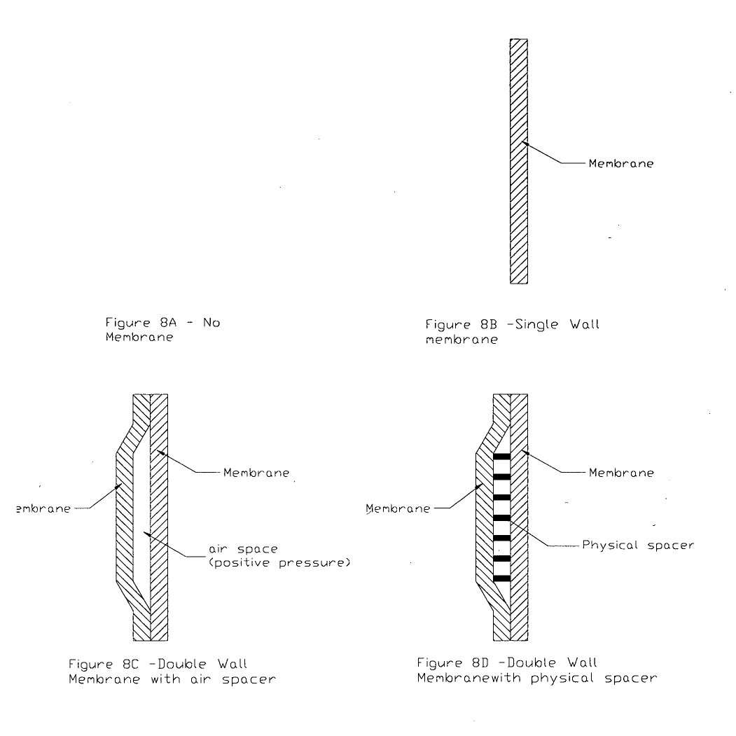

Chamber A includes a water reservoir (humidity source) and the option of a membrane type 1 via an orifice (orifice A) into chamber B plus some technique to place water (humidity) source in chamber A. FIG. 8A, FIG. 8B, FIG. 8C, and FIG. 8D provides the different membrane cross-sections options for membrane type 1 and membrane type 2. FIG. 8A is the no membrane option and is a blank drawing. The option of a membrane type 1 is for practical consideration: to keep water out of the food storage chamber when the BBB is moved. If the BBB is not movable, then the membrane type 1 is not required. If the membrane type 1 is not used, the BBB is a single chamber device. If membrane type 1 is employed, a wide selection of membranes can be used such as 1) a membrane that changes permeance as a function of humidity can be used or 2) a membrane that has the same or near the same permeance for water and water vapor. In addition, the orifice A size between the chamber A and B may be built to allow changing the orifice size. This in turn would allow adjusting the storage chamber's relative humidity after manufacturing.

Chamber B includes a membrane type 2 between the inside of the BBB and the exterior of the BBB via orifice B. This membrane has a permeance that increases with higher relative humidity such as MEMBRAIN® by CertainTeed. Chamber B includes a door to allow access to the inside of chamber B to place items to be stored plus a second orifice (orifice A) and membrane type 1 for water vapor to enter chamber B from chamber A. In addition, the orifice B size to the exterior of the BBB may be built to allow changing the orifice size. This in turn would allow adjusting the storage chamber's relative humidity after manufacturing.

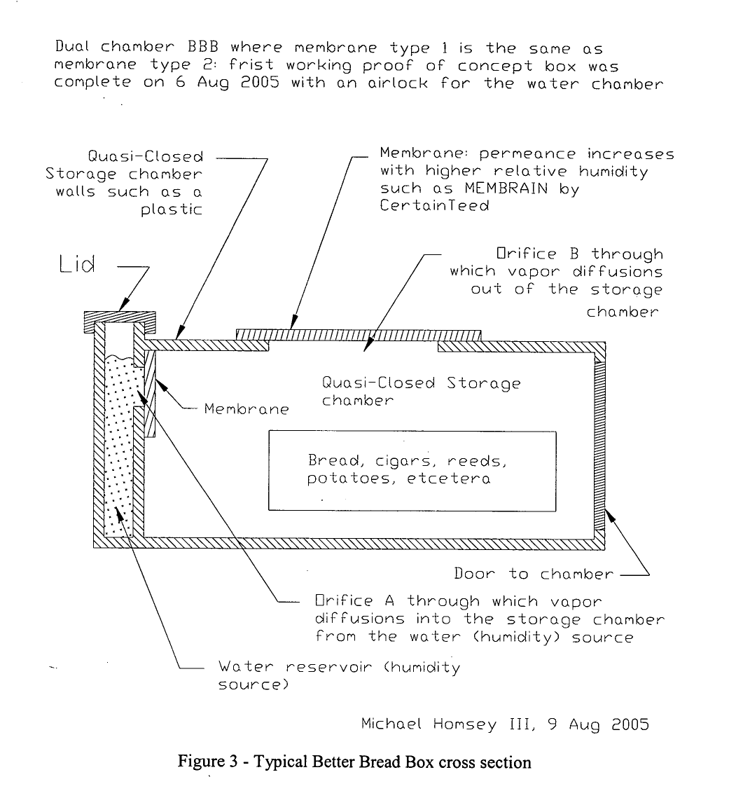

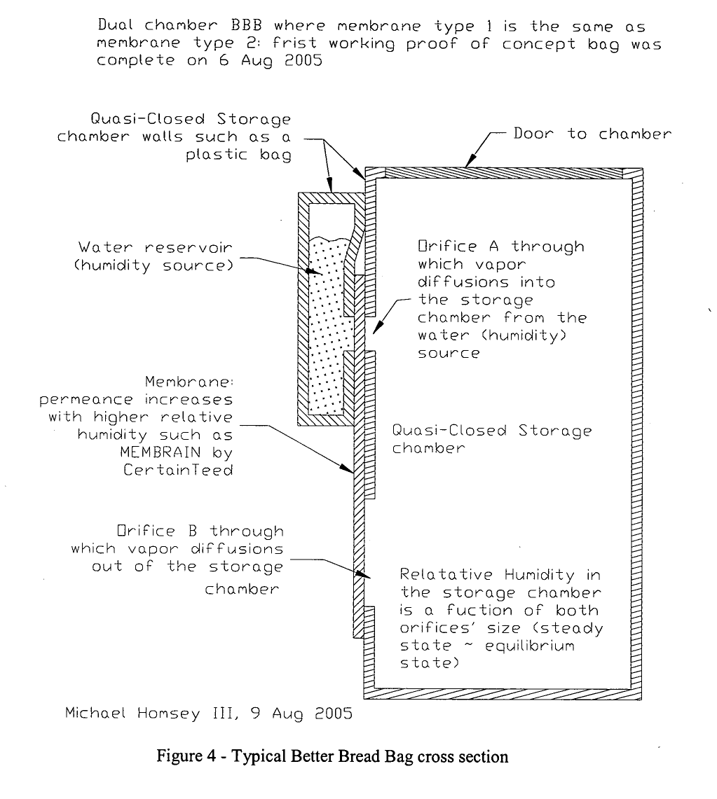

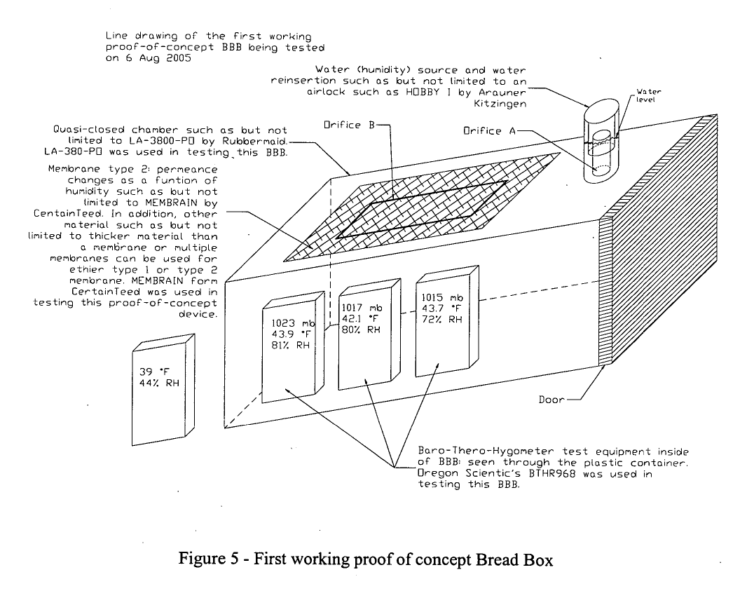

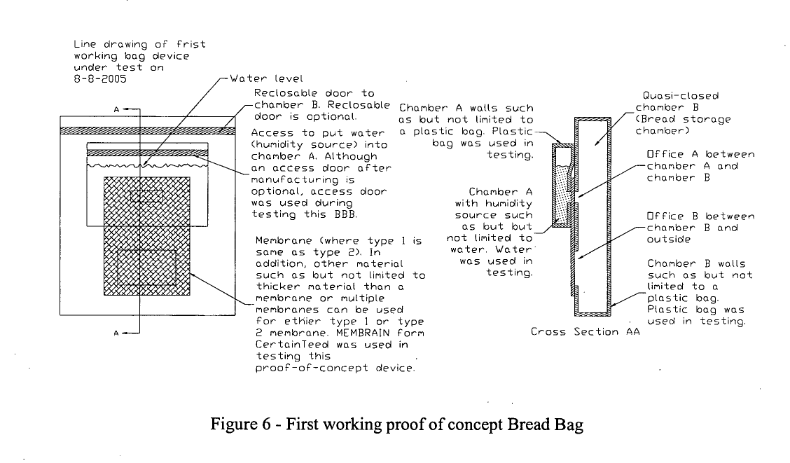

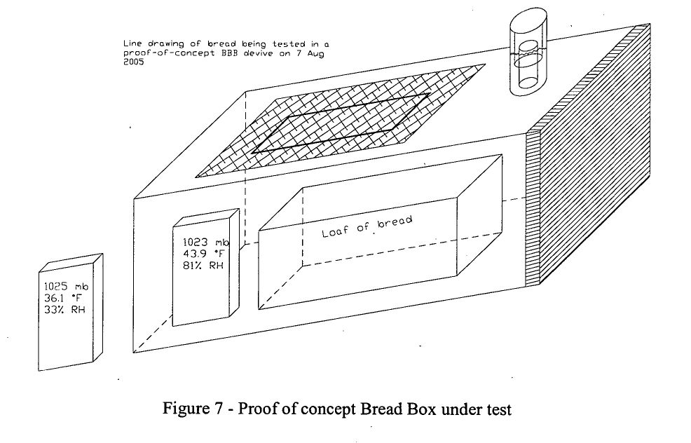

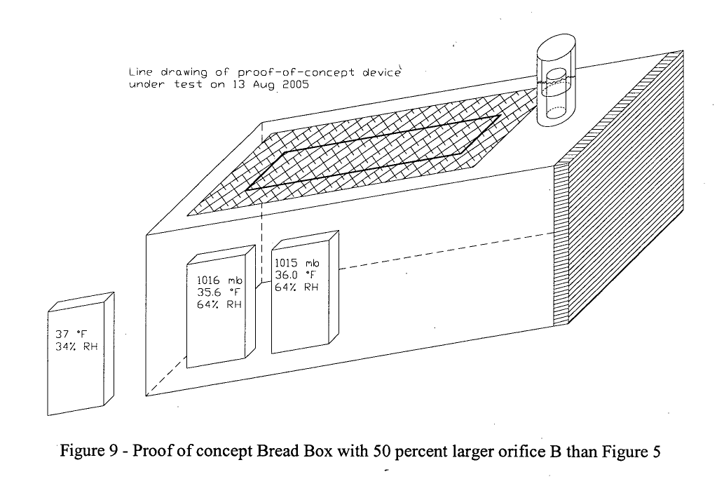

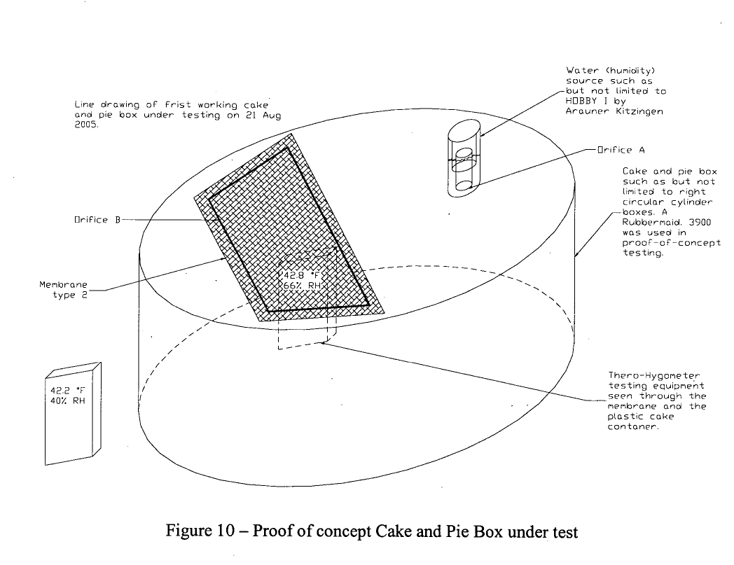

FIG. 3 and FIG. 4 are typical cross section of breadboxes and bread bag, respectively FIG. 5 and FIG. 6 are pictures of the first working proof of concept BBBs. FIG. 7 is a picture of the proof of concept BBB undergoing testing. FIG. 9 is the proof of concept BBB with a 50% larger orifice B. This (FIG. 9) proof of concept BBB was built to verify that changing the orifices B size would change the relative humidity level. FIG. 10 is a proof of concept Cake and Pie Box under test using the BBB technology.

Although not required, the intended use of the BBB is inside of a low humidity refrigerator, such as a residential refrigerator. The refrigerator should typically be operated between 33° F. to 70° F. The temperature of the refrigerator will depend on the items to be stored. For example: some cigars should be stored between 68° F. to 70° F. and have a 70% to 72% relative humidity. Bread can be stored at lower temperatures than some cigars. To enhance mitigating mold growth on bread, the BBB should be used at the lower temperatures over the BBB typical operating range between 33° F. to 70° F.: 40° F. is better than 70° F. Water (humidity source) should be placed in chamber 1 and the items to be stored should then be placed in chamber 2. The BBB should then be placed in a refrigerator that is typically operated between 33° F. to 70° F. For BBB with adjustable relative humidity settings, the setting should be set to the optimum relative humidity of the item to be stored. Some fully shelf contained BBB with refrigeration and a RFID (Radio frequency identification) tag will automatically set the optimum storage temperature and relative humidity for the items placed in the BBB.

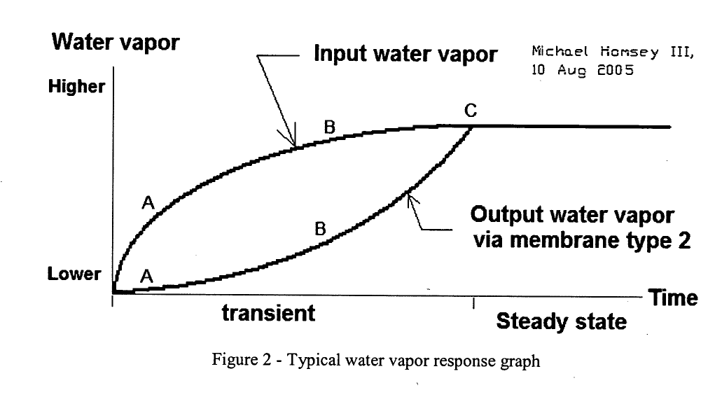

A single chamber Homsey's Better Bread Box regulates relative humidity as follows. First, a single chamber BBB does not have a membrane type 1. Assume the initial state of the bread storage chamber has a 10% relative humidity and the membrane type 2 has a low water vapor permeance, which means that very little water vapor is transmitted through membrane type 2. As water evaporates into the chamber, the chamber humidity increases, which result in a change in the membrane type 2 permeance. See FIG. 2—Typical water vapor response graph. The higher membrane permeance allows more water vapor to transmit through membrane type 2. As the humidity rises in the storage chamber, a point of equilibrium will be reached between water vapor evaporation and the amount of water vapor that is transmitted through the membrane. This equilibrium point, point C on the graph, will define the steady-state relative humidity of the quasi-closed bread storage chamber.

1. Homsey's Better Bread Box and Bag allows a residential occupant to mitigate the problem of bread drying out in low relative humidity refrigerators by maintaining high relative humidity in a quasi-closed storage chamber, therefore allowing the use of residential refrigerators to mitigate molding without bread drying out:
1.1. Use of a Quasi-closed chamber with a water reservoir (humidity source) to extend the shelf-life of items such as but not limited to breads, reeds (for musical instruments), cakes, pies, cigars, potatoes and many other vegetables.
1.2. The Quasi-closed storage chamber uses the principle of water evaporation in a closed container to raise the relative humidity but employs a membrane that allows water vapor to exit the storage chamber through a process such as diffusion.
1.3. The quasi-closed storage chamber's relative humidity level is adjustable via the size of orifices and types of membranes used and can range from the ambient relative humidity to 100 percent relative humidity.
1.4. Use of membranes that changes permeance as a function of humidity and a water reservoir (humidity source) to regulate relative humidity in a quasi-closed storage chamber.
1.5. Homsey's Better Bread Box and Bag is built as a flexible storage bag (like a plastic bread bag) or can be built as a hard box (like a countertop bread box) or be built into refrigeration units.
1.6. The Homsey's Better Bread Box and Bag is used to extend the shelf-life other humidity sensitive items in a refrigerator such as but not limited to breads, cigars, reeds, cakes, potatoes, and other vegetables.
1.7. Use of a membrane between the water reservoir (humidity source) and the quasi-closed storage chamber to keep water from entering the storage chamber.
1.8. Use of a membrane between the water source and the quasi-closed storage chamber to modify the amount of water vapor entering the quasi-closed storage chamber.
1.9. Changing orifice A and or orifice B size to adjust the quasi-closed storage chamber's relative humidity.
1.10. Use of no membrane, single wall membrane, double wall membrane with air spacer, double wall membrane with physical spacers, or any combination there of for membrane type 1 and membrane type 2 in a Homsey's Better Bread Box and Bag that uses a quasi-closed storage chamber.
1.11. Use of RFID (Radio frequency identification) tag or equivalent to specifically adjust the temperature or relative humidity in a Homsey's Better Bread Box and Bag.
1.12. Use of a compatibility seal or written words on a container to state or imply compatibility with the Homsey's Better Bread Box and Bag.
1.13. Any other process to inject water vapor or use of a water reservoir, such as but not limited to air lock, water sprays, and vapor sprays, into the quasi-closed storage chamber to extend the shelf-life of bread or any other items.
1.14. Optional use of a membrane in the Homsey's Better Bread Box and Bag that allows H₂O (water) vapor to diffuse (or transfer) of through the membrane but impedes the diffusion (or transfer) of O₂ (oxygen) through the membrane.
1.15. Use of the Homsey's Better Bread Box and Bag to increase relative humidity without the use of a residential refrigerator.
1.16. Use of a water reservoir to provide water vapor via evaporation (or boiling) to the chambers in the Homsey's Better Bread Box and Bag.
